(19) United States
(12) Patent Application Publication
(10) Pub. No.: US 2026/0349510 A1
(43) Pub. Date: Nov. 5, 2026

(54) Indication of Confidence in Machine-Learned Outputs via Haptic Feedback

(71) Applicant: Google LLC, Mountain View, CA (US)

(72) Inventors: Robert Marchant, Richmond (GB); Henry John Holland, London (GB); Triona Eidin Butler, Kerry (IE); David Matthew Jones, London (GB); Andrew Gregory Spitz, Amsterdam (NL); Ruben van der Vleuten, Amsterdam (NL); Anna Kay Luna Mastenbroek, Amsterdam (NL); Konsantinos Christidis, Thessaloniki (GR)

(21) Appl. No.: 19/118,672

(22) PCT Filed: Dec. 12, 2022
(86) PCT No.: PCT/US2022/052566

§ 371 Date: Apr. 4, 2025

(30) Foreign Application Priority Data
Oct. 4, 2022 (GR) 20220100814

(51) Int. Cl. G06F 3/01

(52) U.S. Cl. CPC G06F 3/016

(57) ABSTRACT

Systems and methods for indicating confidence in a machine-learned output via haptic feedback are provided. For example, a method includes obtaining, by a user computing device, an output of a machine-learned model and an associated confidence metric. The confidence metric is indicative of a degree of confidence in the output of the machine-learned model. The method includes determining a haptic feedback signal indicative of the confidence metric. The method includes receiving data indicative of an input associated with the output of the machine-learned model by a user of the user computing device. The method includes, responsive to receiving the data indicative of the input associated with the output of the machine-learned model, causing performance of the haptic feedback signal for the user via one or more haptic feedback devices.

### FIELD

The present disclosure relates generally to machine learning and haptic feedback. More particularly, the present disclosure relates to indication of a degree of confidence in the outputs of a machine-learned model via haptic feedback.

### BACKGROUND

Machine-learned models can be trained to process an input and provide an output according to a specific task. For example, a machine-learned model may be trained to classify an image as being an image that depicts a human. Generally, however, due to the nature of machine-learned models, a machine-learned model cannot be trained to provide an output that is absolutely certain to be accurate. As such, outputs from machine-learned models are generally associated with some sort of confidence metric. A confidence metric can indicate a degree of confidence in the output of a machine-learned model.

Alongside recent advancements in machine learning, various techniques to communicate increasingly dense quantities of information to users have been developed for user computing devices. Specifically, user computing devices, such as smartphones, tablets, Augmented Reality (AR)/Virtual Reality (VR) devices, etc. have utilized haptic feedback mechanisms to communicate information to users. For example, some smartphones leverage haptic feedback devices, such as vibrational devices, within the smartphone to produce vibrations that indicate that a user has successfully provided a touch input. As another example, some vehicle computing systems leverage haptic feedback devices such as resistance devices to apply variable resistances to a steering column to simulate hydraulic steering for a user.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method for indicating confidence in a machine-learned output via haptic feedback. The method includes obtaining, by a user computing device comprising one or more processors, an output of a machine-learned model and an associated confidence metric, wherein the confidence metric is indicative of a degree of confidence in the output of the machine-learned model. The method includes determining, by the user computing device, a haptic feedback signal indicative of the confidence metric. The method includes receiving, by the user computing device, data indicative of an input associated with the output of the machine-learned model by a user of the user computing device. The method includes, responsive to receiving the data indicative of the input associated with the output of the machine-learned model, causing, by the user computing device, performance of the haptic feedback signal for the user via one or more haptic feedback devices.

Another example aspect of the present disclosure is directed to a computing system. The computing system includes one or more processors. The computing system includes one or more non-transitory computer-readable media that store instructions that, when executed by the one or more processors, cause the computing system to perform operations. The operations include obtaining an input for a machine-learned model from a user computing device of a user. The operations include processing the input with the machine-learned model to obtain an output and an associated confidence metric, wherein the confidence metric is indicative of a degree of confidence in the output. The operations include determining a haptic feedback signal indicative of the confidence metric. The operations include providing the haptic feedback signal to the user computing device, wherein the haptic feedback signal is configured to be performed for the user by one or more haptic feedback devices of the user computing device and/or one or more haptic feedback devices of a computing device communicatively coupled to the user computing device.

Another example aspect of the present disclosure is directed to one or more non-transitory computer-readable media that store instructions that, when executed by one or more processors of a computing system, cause the computing system to perform operations. The operations include obtaining an output of a machine-learned model. The operations include determining a haptic feedback signal, wherein the haptic feedback signal is descriptive of the output of the machine-learned model. The operations include receiving data indicative of an input associated with the output of the machine-learned model by a user of a user device. The operations include, responsive to receiving the data indicative of the input associated with the output of the machine-learned model, causing performance of the haptic feedback signal for the user via one or more haptic feedback devices.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system that performs indication of a degree of confidence in machine-learned outputs via haptic feedback according to example implementations of the present disclosure.

FIG. 1B depicts a block diagram of an example computing device that performs indication of a degree of confidence in machine-learned outputs via haptic feedback according to example embodiments of the present disclosure.

FIG. 1C depicts a block diagram of an example computing device that performs training of a machine-learned model configured to generate a haptic feedback signal according to example embodiments of the present disclosure.

FIG. 2A depicts an example illustration of causing performance of a haptic feedback signal responsive to receiving a user input that selects an output associated with a confidence metric that indicates a low degree of confidence according to some implementations of the present disclosure.

FIG. 2B depicts an example illustration of causing performance of a haptic feedback signal responsive to receiving a user input that selects an output associated with a confidence metric that indicates a high degree of confidence according to some implementations of the present disclosure.

FIG. 2C depicts performance of a variable haptic feedback signal responsive to a continuous user input using one or more haptic feedback devices according to some implementations of the present disclosure.

FIG. 3 depicts an example illustration of causing performance of a haptic feedback signal using a resistance device according to some implementations of the present disclosure.

FIG. 4 depicts a flow chart diagram of an example method to perform indication of a degree of confidence in machine-learned outputs via haptic feedback according to example embodiments of the present disclosure.

FIG. 5 depicts a flow chart diagram of an example method to describe an output of a machine-learned model via haptic feedback according to example embodiments of the present disclosure.

Reference numerals that are repeated across plural figures are intended to identify the same features in various implementations.

### DETAILED DESCRIPTION

### Overview

Generally, the present disclosure is directed to machine learning and haptic feedback. More particularly, the present disclosure relates to indication of a degree of confidence in the outputs of a machine-learned model via haptic feedback. As an example, a user computing device utilized by a user, such as a smartphone device, can obtain an output of a machine-learned model (e.g., a classification output, a generative output, etc.) and an associated confidence metric. The confidence metric can indicate a degree of confidence associated with the output of the machine-learned model (e.g., 90% confidence, etc.). For example, the user may provide a spoken utterance to the user computing device for translation to text (i.e., for text-to-speech purposes). The user computing device can process the spoken utterance using a machine-learned model trained for speech recognition tasks to obtain a machine-learned speech recognition output and an associated confidence metric. The confidence metric can indicate a degree of confidence in the machine-learned speech recognition output (e.g., a degree of confidence in the accuracy of the output, etc.).

The user computing device can determine a haptic feedback signal that describes the confidence metric. To follow the previous example, if the confidence metric associated with the machine-learned speech recognition output describes a relatively low degree of confidence, the user computing device may determine a haptic feedback signal for a low degree of vibrational feedback. Alternatively, if the confidence metric associated with the machine-learned speech recognition output describes a relatively high degree of confidence, the user computing device may determine a haptic feedback signal for a high degree of vibrational feedback.

The user computing device can receive data indicative of an input associated with the output of the machine-learned model by a user of the user computing device. For example, the user computing device may receive a touchscreen input that selects an output (e.g., an output image, etc.) depicted in a region of the touchscreen. In response, the user computing device can cause performance of the haptic feedback signal for the user via one or more haptic feedback devices. For example, the user computing device may be a smartphone device that the user is holding in their hand. The haptic feedback devices may be a number of vibrational feedback devices located within the smartphone that are configured to provide vibrations according to a haptic feedback signal. The user computing device can cause performance of the haptic feedback signal via the vibrational devices.

As such, while providing an output to a user, the user computing device can concurrently provide an indication as to the degree of confidence associated with the output. To follow the previous example, the speech recognition output may be provided to the user as a textual string within a query field of a search application. Concurrently, the user computing device can cause performance of a haptic feedback signal that indicates a low degree of confidence associated with the speech recognition output. Once the haptic feedback signal is performed for the user, the user may decide to discard the speech recognition output and provide a new spoken utterance, rather than trying to determine if any inaccuracies exist within the speech recognition output. In such fashion, the depth and quality of data provided to users can be enhanced, therefore increasing the efficiency of the user decision-making process.

Implementations of the present disclosure provide a number of technical effects and benefits. As one example technical effect and benefit, users of computing devices, such as smartphones, often receive outputs of machine-learned models without receiving an associated confidence metric. Provision of this confidence metric can facilitate more efficient decision-making by users. For example, a user can provide a spoken utterance for machine-learned dictation in a messaging application, and in return may receive a dictation output (e.g., a textual string) within an input field of the messaging application. However, without any indication as to the degree of confidence associated with the dictation output, the user may unnecessarily spend time verifying the accuracy of the dictation output, therefore wasting compute resources (e.g., compute cycles, power, memory, storage, bandwidth, etc.). Accordingly, implementations of the present disclosure facilitate indication of this degree of confidence via haptic feedback. By providing the degree of confidence to the user, utilization of compute resources due to the user's lack of knowledge of the degree of confidence can be substantially reduced, or eliminated.

With reference now to the Figures, example embodiments of the present disclosure will be discussed in further detail.

### Example Devices and Systems

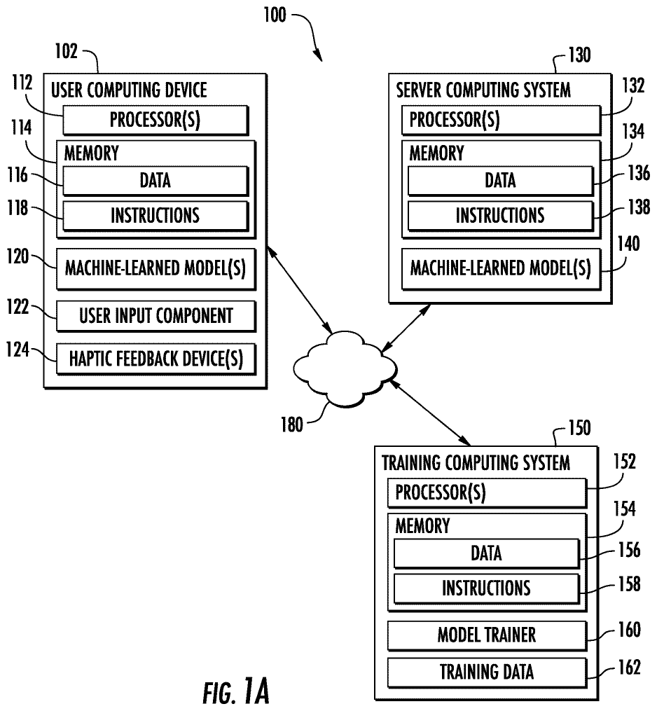

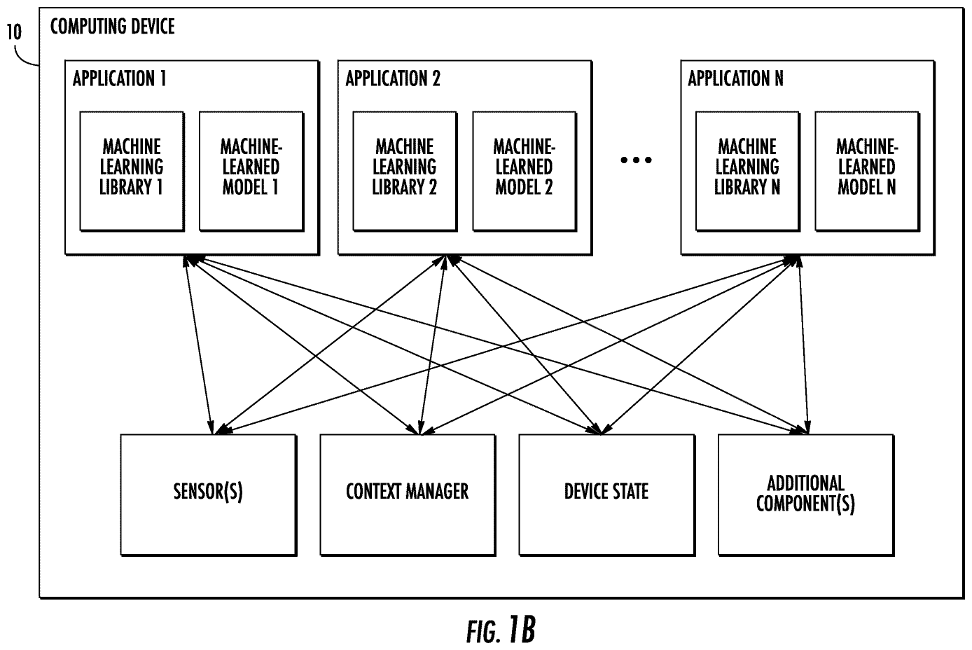

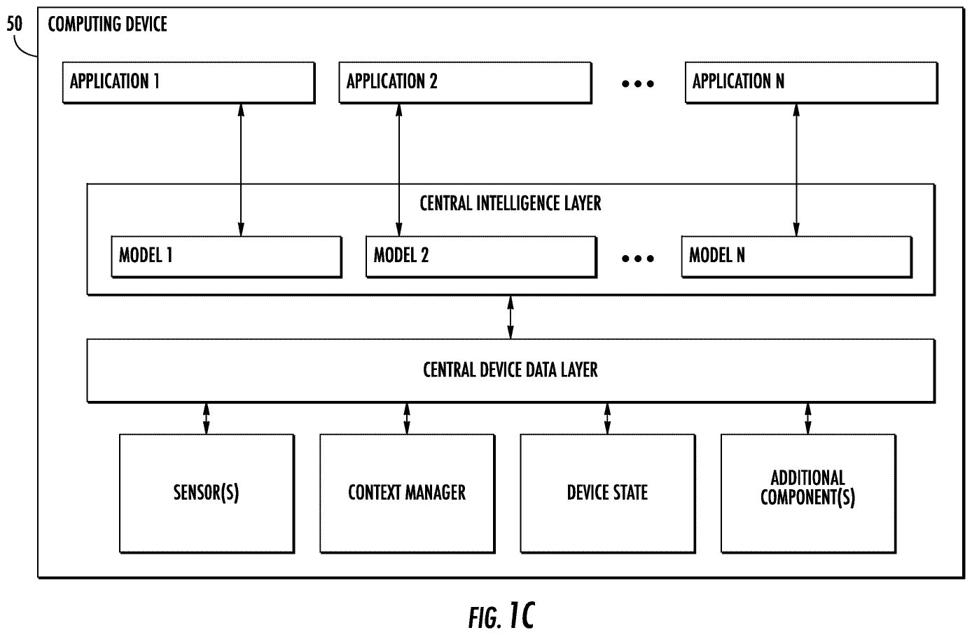

FIG. 1A depicts a block diagram of an example computing system 100 that performs indication of a degree of confidence in machine-learned outputs via haptic feedback according to example implementations of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, an FPGA, a controller, a microcontroller, etc.) and can be one processor or a plurality of processors that are operatively connected. The memory 114 can include one or more non-transitory computer-readable storage media, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models).

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120 (e.g., to perform parallel processing across multiple instances of the machine-learned model).

Additionally, or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 130 as a portion of a web service (e.g., a classification service, a generative service, etc.). Thus, one or more models 120 can be stored and implemented at the user computing device 102 and/or one or more models 140 can be stored and implemented at the server computing system 130.

The user computing device 102 can also include one or more user input components 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The user computing device can include one or more haptic feedback devices 124. The haptic feedback device(s) 124 can be any sort of device sufficient to perform haptic feedback according to a haptic feedback signal. For example, in some implementations the haptic feedback device(s) 124 may include a number of vibrational devices located in different regions of the user computing device (e.g., to provide multi-dimensional vibration feedback) that are configured to vibrate according to a haptic feedback signal (e.g., a linear resonant actuator array, etc.). Additionally, or alternatively, in some implementations the haptic feedback device(s) 124 may include a resistance device (e.g., a brushless DC motor, a magnetic particle brake, etc.) configured to apply a variable resistance to the user input component 122 according to the haptic feedback signal (e.g., a brushless direct current motor, etc.). For example, the user input component 122 may be a temperature selection dial for a home thermostat device. The resistance device can apply a variable resistance to the selection dial according to the haptic feedback signal.

Additionally, or alternatively, in some implementations the haptic feedback device(s) 124 may include a haptic texture device configured to simulate a texture on a display device or a touch input device (e.g., via electrovibrations, etc.). For example, the confidence metric may indicate a low degree of confidence for a first image output and a high degree of confidence for a second image output. According to the haptic feedback signal, the haptic texture device may simulate a rough texture on a touchscreen device of the user computing device 102 in the region of the touchscreen in which the first image is displayed, and may simulate a smooth texture in the region in which the second image is displayed.

Additionally, or alternatively, in some implementations the haptic feedback device(s) 124 may include an actuator (e.g., a linear actuator, etc.). For example, the user may be provided images as outputs of the machine-learned model in order of their associated confidence metrics (i.e., an image with the highest associated confidence metric is provided first while the image with the lowest associated confidence metric is provided last). The user input component 122 may be a physical device that allows the user to scroll through the images (e.g., a scroll wheel on a mouse device, a one-dimensional input element that can be moved vertically, etc.). The actuator can be utilized to increase resistance against the user's scrolling input to signal to the user that the confidence metrics associated with the images are increasingly lower.

Additionally, or alternatively, in some implementations the haptic feedback device(s) 124 may include an audio output device. For example, the confidence metric may indicate a low degree of confidence for one portion of a dictation output and a high degree of confidence for another portion of the dictation output (e.g., a text-to-speech output, etc.). The dictation output can be played back to the user via the audio output device so that the user can confirm the accuracy of the dictation output. Concurrently, the audio output device can be utilized to modify the pitch, equalization, volume, playback speed, etc. of the dictation output according to the haptic feedback signal. For example, the audio output device may increase playback speed for portions of the dictation output associated with a high degree of confidence. For another example, the audio output device may lower the playback volume for portions of the dictation output associated with a high degree of confidence.

Additionally, or alternatively, in some implementations the haptic feedback device(s) 124 may include a display device. For example, the confidence metric may indicate a low degree of confidence for some image outputs and a high degree of confidence for other image outputs (e.g., responsive to a reverse image search query, etc.). The images can be displayed to the user via the display device. Concurrently, the display device can be utilized to modify visual aspects of the images according to the haptic feedback signal (e.g., brightness, contrast, color, etc.). For example, the display device may dim the brightness in a region of the display device that includes images associated with a low degree of confidence. For another example, the display device may increase the contrast in a region of the display device that includes images associated with a high degree of confidence.

The server computing system 130 includes one or more processors 132 and a memory 134. The one or more processors 132 can be any suitable processing device (e.g., a processor core, a microprocessor, an ASIC, an FPGA, a controller, a microcontroller, etc.) and can be one processor or a plurality of processors that are operatively connected. The memory 134 can include one or more non-transitory computer-readable storage media, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models).

In some implementations, the server computing system 130 may receive an input for the machine-learned model(s) 140 from the user computing device 102. For example, the user computing device 102 may provide an image via the network 180 for processing using the machine-learned model(s) 140. The server computing system 130 can process the image with the machine-learned model(s) 140 to receive an output and an associated confidence metric. In some implementations, the server computing system 130 can transmit the output and the associated confidence metric to the user computing device 102 via the network 180. Upon receipt of the output and the associated confidence metric, the user computing device 102 can determine a haptic feedback signal descriptive of the confidence metric. The user computing 102 device can cause performance of the haptic feedback signal for the user via the haptic feedback device(s) 124 responsive to receiving data indicative of an input associated with the output of the machine-learned model 120 from a user of the user device 102.

Alternatively, in some implementations, the user computing device 102 may process the image with the machine-learned model(s) 120 to receive the output and the associated confidence metric. The user computing device 102 can determine a haptic feedback signal descriptive of the confidence metric. The user computing 102 device can cause performance of the haptic feedback signal for the user via the haptic feedback device(s) 124 responsive to receiving data indicative of an input associated with the output of the machine-learned model 120 from a user of the user device 102.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, an FPGA, a controller, a microcontroller, etc.) and can be one processor or a plurality of processors that are operatively connected. The memory 154 can include one or more non-transitory computer-readable storage media, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM, hard disk, or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

The machine-learned models described in this specification may be used in a variety of tasks, applications, and/or use cases.

In some implementations, the input to the machine-learned model(s) of the present disclosure can be image data. The machine-learned model(s) can process the image data to generate an output. As an example, the machine-learned model(s) can process the image data to generate an image recognition output (e.g., a recognition of the image data, a latent embedding of the image data, an encoded representation of the image data, a hash of the image data, etc.). As another example, the machine-learned model(s) can process the image data to generate an image segmentation output. As another example, the machine-learned model(s) can process the image data to generate an image classification output. As another example, the machine-learned model(s) can process the image data to generate an image data modification output (e.g., an alteration of the image data, etc.). As another example, the machine-learned model(s) can process the image data to generate an encoded image data output (e.g., an encoded and/or compressed representation of the image data, etc.). As another example, the machine-learned model(s) can process the image data to generate an upscaled image data output. As another example, the machine-learned model(s) can process the image data to generate a prediction output.

In some implementations, the input to the machine-learned model(s) of the present disclosure can be text or natural language data. The machine-learned model(s) can process the text or natural language data to generate an output. As an example, the machine-learned model(s) can process the natural language data to generate a language encoding output. As another example, the machine-learned model(s) can process the text or natural language data to generate a latent text embedding output. As another example, the machine-learned model(s) can process the text or natural language data to generate a translation output. As another example, the machine-learned model(s) can process the text or natural language data to generate a classification output. As another example, the machine-learned model(s) can process the text or natural language data to generate a textual segmentation output. As another example, the machine-learned model(s) can process the text or natural language data to generate a semantic intent output. As another example, the machine-learned model(s) can process the text or natural language data to generate an upscaled text or natural language output (e.g., text or natural language data that is higher quality than the input text or natural language, etc.). As another example, the machine-learned model(s) can process the text or natural language data to generate a prediction output.

In some implementations, the input to the machine-learned model(s) of the present disclosure can be speech data. The machine-learned model(s) can process the speech data to generate an output. As an example, the machine-learned model(s) can process the speech data to generate a speech recognition output. As another example, the machine-learned model(s) can process the speech data to generate a speech translation output. As another example, the machine-learned model(s) can process the speech data to generate a latent embedding output. As another example, the machine-learned model(s) can process the speech data to generate an encoded speech output (e.g., an encoded and/or compressed representation of the speech data, etc.). As another example, the machine-learned model(s) can process the speech data to generate an upscaled speech output (e.g., speech data that is higher quality than the input speech data, etc.). As another example, the machine-learned model(s) can process the speech data to generate a textual representation output (e.g., a textual representation of the input speech data, etc.). As another example, the machine-learned model(s) can process the speech data to generate a prediction output.

In some implementations, the input to the machine-learned model(s) of the present disclosure can be latent encoding data (e.g., a latent space representation of an input, etc.). The machine-learned model(s) can process the latent encoding data to generate an output. As an example, the machine-learned model(s) can process the latent encoding data to generate a recognition output. As another example, the machine-learned model(s) can process the latent encoding data to generate a reconstruction output. As another example, the machine-learned model(s) can process the latent encoding data to generate a search output. As another example, the machine-learned model(s) can process the latent encoding data to generate a reclustering output. As another example, the machine-learned model(s) can process the latent encoding data to generate a prediction output.

In some implementations, the input to the machine-learned model(s) of the present disclosure can be statistical data. Statistical data can be, represent, or otherwise include data computed and/or calculated from some other data source. The machine-learned model(s) can process the statistical data to generate an output. As an example, the machine-learned model(s) can process the statistical data to generate a recognition output. As another example, the machine-learned model(s) can process the statistical data to generate a prediction output. As another example, the machine-learned model(s) can process the statistical data to generate a classification output. As another example, the machine-learned model(s) can process the statistical data to generate a segmentation output. As another example, the machine-learned model(s) can process the statistical data to generate a visualization output. As another example, the machine-learned model(s) can process the statistical data to generate a diagnostic output.

In some implementations, the input to the machine-learned model(s) of the present disclosure can be sensor data. The machine-learned model(s) can process the sensor data to generate an output. As an example, the machine-learned model(s) can process the sensor data to generate a recognition output. As another example, the machine-learned model(s) can process the sensor data to generate a prediction output. As another example, the machine-learned model(s) can process the sensor data to generate a classification output. As another example, the machine-learned model(s) can process the sensor data to generate a segmentation output. As another example, the machine-learned model(s) can process the sensor data to generate a visualization output. As another example, the machine-learned model(s) can process the sensor data to generate a diagnostic output. As another example, the machine-learned model(s) can process the sensor data to generate a detection output.

In some cases, the machine-learned model(s) can be configured to perform a task that includes encoding input data for reliable and/or efficient transmission or storage (and/or corresponding decoding). For example, the task may be an audio compression task. The input may include audio data and the output may comprise compressed audio data. In another example, the input includes visual data (e.g., one or more images or videos), the output comprises compressed visual data, and the task is a visual data compression task. In another example, the task may comprise generating an embedding for input data (e.g., input audio or visual data).

In some cases, the input includes visual data and the task is a computer vision task. In some cases, the input includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some cases, the input includes audio data representing a spoken utterance and the task is a speech recognition task. The output may comprise a text output which is mapped to the spoken utterance. In some cases, the task comprises encrypting or decrypting input data. In some cases, the task comprises a microprocessor performance task, such as branch prediction or memory address translation.

FIG. 1A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 1B depicts a block diagram of an example computing device 10 that performs indication of a degree of confidence in machine-learned outputs via haptic feedback according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs training of a machine-learned model configured to generate a haptic feedback signal according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

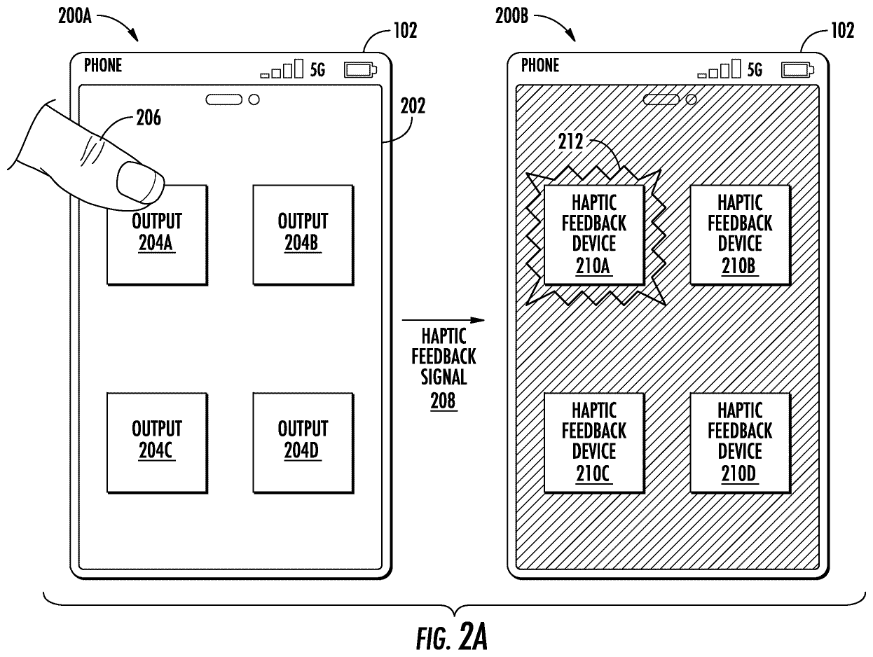

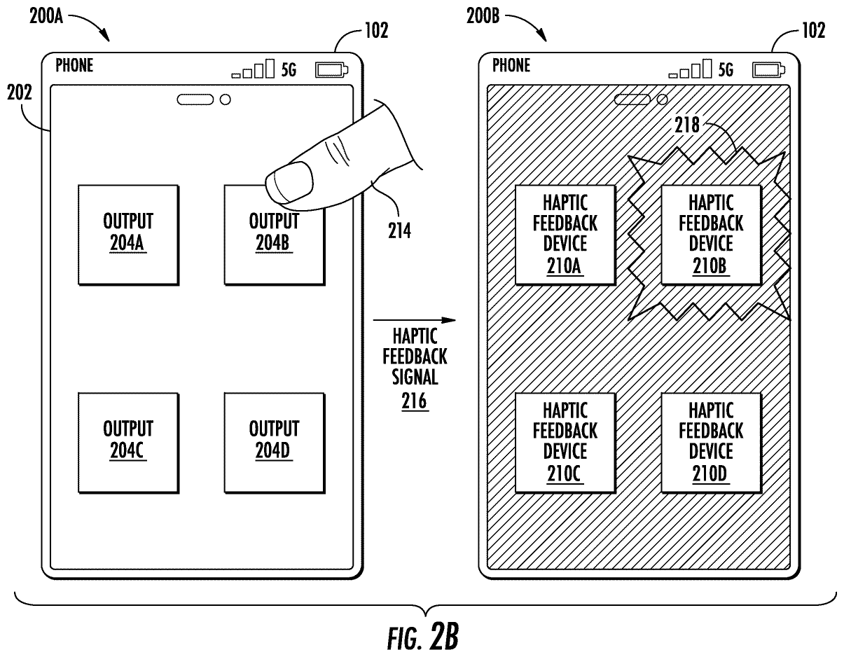

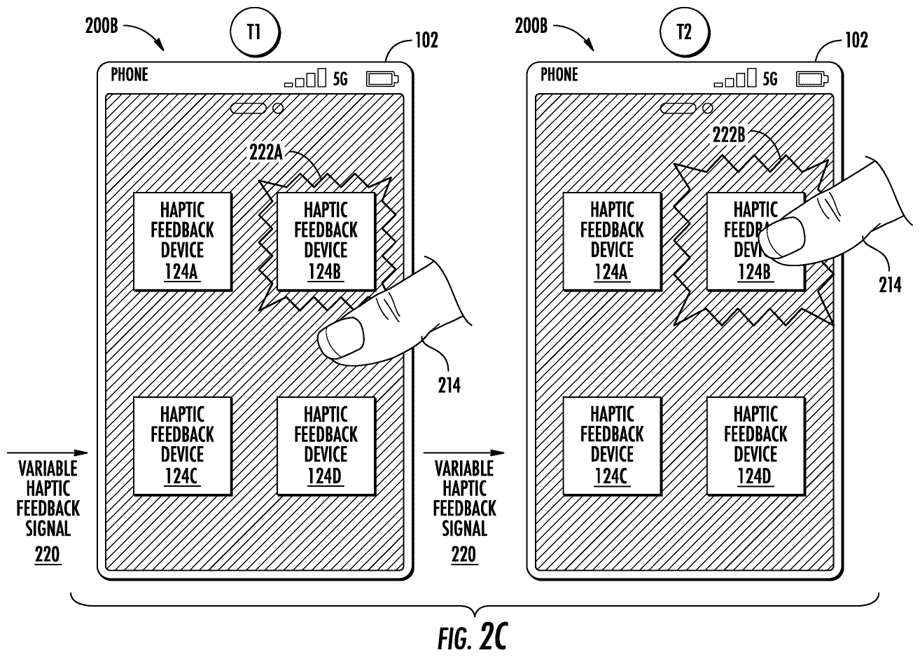

FIG. 2A depicts an example illustration of causing performance of a haptic feedback signal responsive to receiving a user input that selects an output associated with a confidence metric that indicates a low degree of confidence according to some implementations of the present disclosure. Specifically, an external view 200A of the user computing device of FIG. 1A is illustrated. As illustrated, the user computing device 102 depicts a display device 202. The user computing device 102 has obtained outputs 204A, 204B, 204C, and 204D from a machine-learned model, and has obtained confidence metrics associated with each of the outputs 204A-204D. The user computing device 102 utilizes the display device 202 to display the outputs 204 to a user of the user computing device 102. For example, the outputs 204A-204D may be images obtained as outputs from a machine-learned model responsive to a user image query.

Once the outputs 204A-204D are received, the user computing device 102 can determine a haptic feedback signal 208 for each of the outputs 204A-204D. For example, the user computing device 102 can determine a haptic feedback signal 208 for output 204A that indicates the confidence metric associated with the output 204A. If the confidence metric associated with the output 204A is relatively high, the haptic feedback signal 208 may indicate the high degree of confidence via strong signal to a haptic feedback device 124 associated with the region of the display device 202 in which the output 204A is displayed.

The user can provide a touch input 206 to the user computing device 102 via the display device 202 (e.g., a touch input to a touch screen device 202, etc.). The touch input 206 is an input that is associated with the output 204A. Specifically, as depicted, the touch input 206 selects the output 204A. The user computing device 102 can receive data that indicates the input 206 (e.g., an input associated with the output of the machine-learned model, etc.). In response, the user computing device 102 can cause performance of the haptic feedback signal 208 for the user via one or more haptic feedback devices 210A, 210B, 210C, and/or 210D.

Specifically, view 200B is an internal view of the user computing device 102. As illustrated, the user computing device includes a number of haptic feedback devices 210A-210D that are configured to vibrate according to the haptic feedback signal 208 (e.g., a LRA array, etc.), such as haptic feedback device(s) 124 of FIG. 1A. For example, the confidence metric associated with the output 204A can indicate a relatively low degree of confidence for the output 204A. To indicate the confidence metric, the haptic feedback signal 210 can be, or otherwise indicate, a relatively low vibration effect 212 from the haptic feedback device 210A which is positioned under the region of the display device 202 that depicts the output 204A. In such fashion, the user computing device 102 can indicate the relatively low degree of confidence associated with the output 204A to the user by causing performance of the haptic feedback signal 208 using the haptic feedback device 210A.

It should be noted that the haptic feedback devices 210 that are configured to produce vibrations according to the haptic feedback signal 208 are not the only haptic feedback devices that can be utilized. Rather, any haptic feedback device, or combination of haptic feedback devices, may be utilized to perform the haptic feedback signal for the user. For example, the haptic feedback device 210 may be, or otherwise include, electrovibrational device(s) configured to modulate the texture of the display device 202 according to the haptic feedback signal 208 (e.g., modifying the region of the display device, etc.).

FIG. 2B depicts an example illustration of causing performance of a haptic feedback signal responsive to receiving a user input that selects an output associated with a confidence metric that indicates a high degree of confidence according to some implementations of the present disclosure. Specifically, as depicted, after providing the input 206 of FIG. 2A, the user can provide a second input 214 to the display device 202 of the user computing device 102. The second input 214 can be associated with the output 204B. Specifically, the second input 214 can select the output 204B via a touch input to the display device 202. The user computing device 102 can receive data that indicates the second input 214 (e.g., an input associated with the output of the machine-learned model, etc.). In response, the user computing device 102 can cause performance of the haptic feedback signal 216 for the user via the one or more haptic feedback devices 210.

For example, the confidence metric associated with output 204B may indicate a relatively high degree of confidence. To indicate the confidence metric, the haptic feedback signal 216 can be, or otherwise indicate, a relatively high vibration effect 218 from the haptic feedback device 210B which is positioned under the region of the display device 202 that depicts the output 204B. In such fashion, the user computing device 102 can indicate the relatively high degree of confidence associated with the output 204B to the user by causing performance of the haptic feedback signal 216 using the haptic feedback device 210B.

FIG. 2C depicts performance of a variable haptic feedback signal responsive to a continuous user input using one or more haptic feedback devices according to some implementations of the present disclosure. Specifically, as depicted, the second input 214 may be a touch-and-hold input. At time T1, the second input 214 can be positioned at a region of the display device 202 that is below the region of the screen in which the output 204B is depicted. Rather than determining the haptic feedback signal 216, the user computing device 102 may instead determine a variable haptic feedback signal 220. The variable haptic feedback signal 220 can be a haptic feedback signal that varies based on a proximity between a user input and a corresponding output of the machine-learned model. For example, the variable haptic feedback signal 220 may be a signal that increases as a user input decreases in proximity to a corresponding output.

According to the variable haptic feedback signal 220, as the second input 214 is proximate to the region of the display device 202 in which the output 204B is depicted at time T1, the performance of variable haptic feedback signal 220 can cause a relatively low vibrational effect 222A at time T1 that corresponds to the proximity of the second input 214 from the region of the screen that depicts the output 204B at time T1.

However, at time T2, the position of the second input 214 (i.e., the “touch-and-hold” input) can change such that the second input 214 is positioned directly in the region of the display device 202 in which the output 204B is depicted. According to the variable haptic feedback signal 220, as the second input 214 is proximate to the region of the display device 202 in which the output 204B is depicted at time T2, the performance of variable haptic feedback signal 220 can cause a relatively high vibrational effect 222B at time T2 that corresponds to the proximity of the second input from the region of the screen that depicts the output 204B at time T2. In such fashion, the user computing device 102 can cause performance of the variable haptic feedback signal 220 as the proximity of the second input 214 to the region of the display device 202 that depicts the output 204B varies.

It should be noted that the variable haptic feedback signal 220 can be the same haptic feedback signal as the haptic feedback signal 216 of FIG. 2B. For example, the user computing device 102 may vary performance of the haptic feedback signal 216 according to the proximity of the second input 214. In other words, the variable haptic feedback signal 220 may be a haptic feedback signal, such as haptic feedback signal 216, that is performed in a variable manner by the user computing device 102.

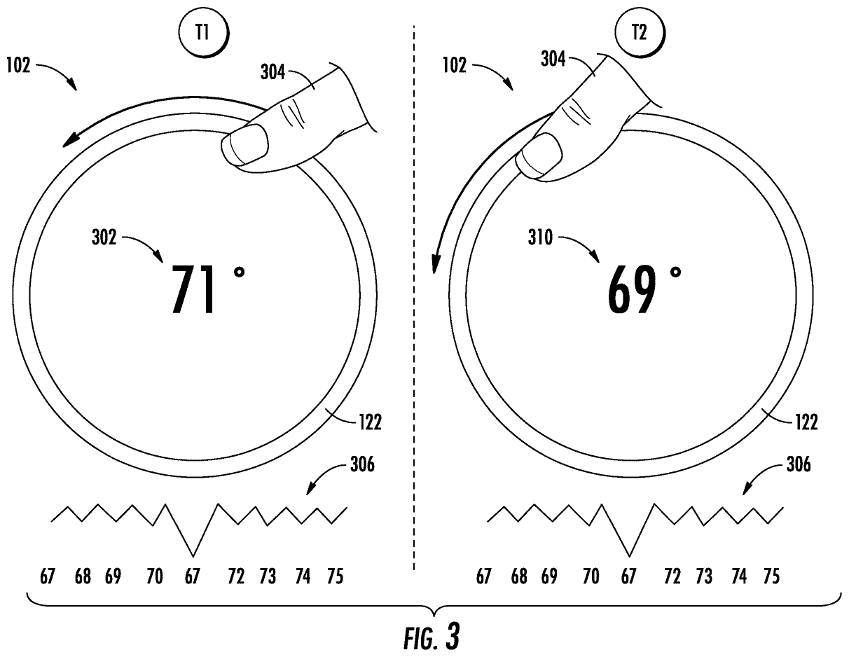

FIG. 3 depicts an example illustration of causing performance of a haptic feedback signal using a resistance device according to some implementations of the present disclosure. Specifically, as depicted, the user computing device 102 can be, or can be communicatively coupled to, a thermostat device configured to adjust a temperature of a room. The temperature can be an output 302 of a machine-learned model. For example, the machine-learned model may be a temperature prediction model configured to provide an optimal temperature output 302 for a user (e.g., to reduce energy usage, etc.). The user computing device 102 can be controlled via user input component 122 of FIG. 1A. As depicted, the user input component 122 can be a radial input device that produces a haptic feedback effect according to a haptic feedback signal 306 as the user provides an input 304.

For example, the user input 304 can be an input that turns the user input component 122 in a leftward direction. The user computing device 102 can be configured to cause performance of haptic feedback signal 306 each time the user input 304 causes the user input component 122 to select a different output of the machine-learned model (e.g., a different temperature).

Specifically, the machine-learned model may generate a predicted temperature or range of temperatures that are optimal for a user according to a certain task (e.g., minimizing energy expenditure while maintaining user satisfaction, etc.). For example, the machine-learned model (e.g., machine-learned model 120 of FIG. 1A, etc.) may predict a range of temperatures between 65-75 degrees. Each temperature within the range can have an associated confidence metric.

The user computing device 102 can determine a haptic feedback signal 306 for each confidence metric. For example, the confidence metric associated with output 302 at time T1 (e.g., 71 degrees) may indicate a very high degree of certainty. The user computing device 102 can determine a haptic feedback signal 306 indicative of the confidence metric. The haptic feedback signal 306 can be, or otherwise indicate, a haptic feedback effect that occurs as the user input 304 navigates away from the output 302 at time T1. For example, the haptic feedback signal 306 may indicate a strong haptic feedback effect for one or more haptic feedback devices (e.g., haptic feedback device(s) 124 of FIG. 1) as the user input 304 navigates away from the output 302 (e.g., navigating from 71 to 70). For example, the haptic feedback device(s) may be a resistance device that applies a strong resistance against the user input 304 at time T1. For another example, the haptic feedback device(s) may be audio playback devices that increase the volume of a click noise output by the audio playback devices concurrently with navigation away from the output 302 by user input 304.

As depicted, at time T2, the user input 304 can continue to navigate to outputs 302 associated with lower temperatures. Specifically, the user has navigated from output 302 (e.g., a temperature of 71 degrees) to output 310 (e.g., a temperature of 69 degrees). As the user input 304 continues to navigate via the user input component 122 at time T2, the haptic feedback signal may indicate a haptic feedback effect different than the effect performed at time T1. For example, the haptic feedback effect indicated by the haptic feedback signal 306 at time T1 may be a strong resistance applied by resistance devices corresponding to a strong degree of confidence associated with the output 302. However, at time T2, the haptic feedback effect indicated by the haptic feedback signal 306 may be a weak resistance applied by resistance devices corresponding to a weak degree of confidence associated with the output 302. In such fashion, the user computing device 102 can cause performance of the haptic feedback signal 306 for the user via one or more haptic feedback devices.

### Example Methods

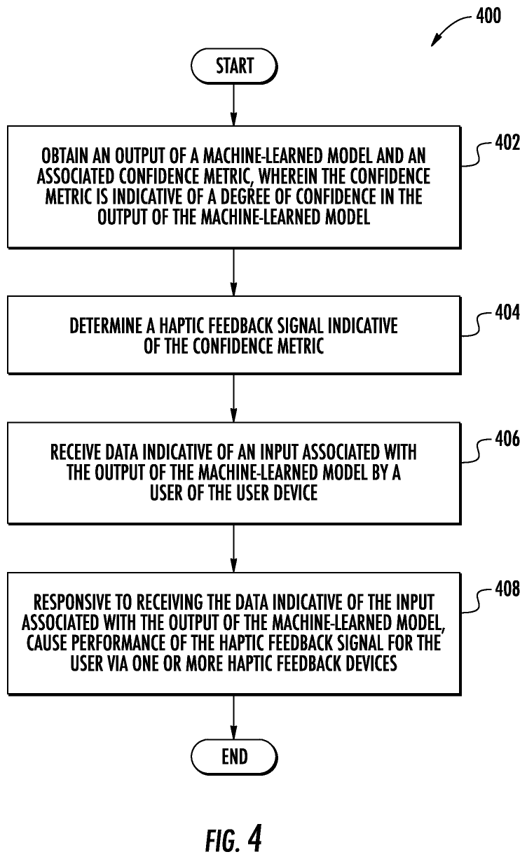

FIG. 4 depicts a flow chart diagram of an example method 400 to perform indication of a degree of confidence in machine-learned outputs via haptic feedback according to example embodiments of the present disclosure. Although FIG. 4 depicts steps performed in a particular order for purposes of illustration and discussion, the methods of the present disclosure are not limited to the particularly illustrated order or arrangement. The various steps of the method 400 can be omitted, rearranged, combined, and/or adapted in various ways without deviating from the scope of the present disclosure.

It should be noted that the various steps of method 400 are discussed with regards to a computing system. However, this computing system may also refer to a computing device, such as a user computing device, or a server computing system communicatively coupled to a user computing device. As such, it should be broadly understood that within the context of FIG. 4, a computing system may refer to any computing device, collection of computing devices, processor(s), etc.

At 402, a computing system can obtain an output of a machine-learned model and an associated confidence metric. The confidence metric can be indicative of a degree of confidence in the output of the machine-learned model. For example, the machine-learned model can be a machine-learned classification model, and the output of the model can be a classification output that assigns a classification to an entity (e.g., classifying an input image as depicting dogs, etc.). The confidence metric can indicate a degree of confidence in the classification assigned to the entity (e.g., 70% confidence that the input image does depict dogs, etc.).

In some implementations, obtaining the output of the machine-learned model and the associated confidence metric includes processing input data with the machine-learned model to obtain the output. The confidence metric can be determined based at least in part on one or more prior outputs of the machine-learned model. For example, the output can be a classification output that classifies an image as depicting dogs or not depicting dogs. The prior output(s) of the machine-learned model may have been determined to be incorrect. Accordingly, the confidence metric may be determined to indicate a relatively low degree of confidence in the output of the machine-learned model.

Alternatively, in some implementations, obtaining the output and the confidence metric includes providing the input to a separate computing system (e.g., a machine-learning service computing system, etc.). Responsively, the computing system can obtain the output and the associated confidence metric from the separate computing system. In other words, the separate computing system can process the input with the machine-learned model to obtain the output, and can determine the confidence metric for the output. Then, the separate computing system can provide the output and associated confidence metric to the computing system.

At 404, the computing system can determine a haptic feedback signal indicative of the confidence metric. The haptic feedback signal can be, or otherwise indicate, a haptic effect to be performed via one or more haptic devices. For example, the haptic feedback signal may be, or otherwise indicate, a relatively high vibrational effect performed by an array of vibration-causing haptic feedback devices. In some implementations, the haptic feedback signal may be software instructions that cause performance of a haptic feedback effect when provided to haptic feedback devices, or when provided to computing devices that include or are communicatively coupled to the haptic feedback devices.

In some implementations, to determine the haptic feedback signal, the computing system can determine the haptic feedback signal indicative of the confidence metric based at least in part on user historical data. The user historical data can describe of one or more prior haptic feedbacks signals that were previously performed for the user via the one or more haptic feedback devices. For example, the user historical data may indicate that prior haptic feedback signals for vibrational devices were relatively ineffective at indicating information to the user. In response, the computing system may determine a haptic feedback signal for a different haptic feedback device (e.g., an actuator, etc.).

At 406, the computing system can receive data indicative of an input associated with the output of the machine-learned model by a user of the user computing device. In some implementations, the input may be a touch input to a touchscreen device of the computing system (e.g., a user computing device, etc.) that selects an interface element associated with the output. For example, the machine-learned model may be a machine-learned query model that retrieves images based on an image query, and the degree of confidence can indicate a degree of confidence for each retrieved image. The retrieved images can be presented as interface elements within an interface displayed on the touchscreen device. The touch input can be provided as the user touches a region of the touchscreen device in which the output (e.g., the retrieved image) is depicted.

Alternatively, the input may be a touch input to the touchscreen device that selects a region of the touchscreen device within a certain proximity of the interface element associated with the output. To follow the previous example, the user may drag their finger across the touch screen from one image interface element to another image interface element (e.g., so that the user can receive a dynamically varying haptic feedback signal as described with regards to FIG. 2C). As the user moves their finger (e.g., a touch-and-hold” gesture), the user may select a region o the touchscreen device that does not depict the output, but is within a certain proximity to the output.

In some implementations, the input may be a spoken utterance that indicates the output to an audio capture device of the computing system. For example, the computing system may execute a virtual assistant application. The virtual assistant application may receive an initial spoken utterance input that includes instructions from the user to the virtual assistant application. virtual assistant application can process the spoken utterance input with the machine-learned model to obtain an output that indicates the instructions to the virtual assistant application. The virtual assistant application can output audio that requests a confirmation of the instructions by the user. In response, the user can provide a spoken utterance that indicates the output (e.g., the user saying “yes” or “correct”, etc.).

In some implementations, the input may be a gesture input captured by a video capture sensor or one or more movement sensors of the computing system that indicates the output. To follow the previous example, rather than providing a spoken utterances that indicates the output for the confirmation of the instructions for the virtual assistant application, the user may perform a gesture (e.g., a “thumbs-up” gesture, etc.) that is captured by a video capture device of the computing system. Alternatively, the user may move the computing system (e.g., a smartphone, etc.) in a pattern recognized as an input by the computing system (e.g., shaking the computing system up and down, etc.). Such actions may be captured via movement sensors of the computing system (e.g., accelerometers, gyroscopes, etc.).

At 408, the computing system, responsive to receiving the data indicative of the input associated with the output of the machine-learned model, can cause performance of the haptic feedback signal for the user via one or more haptic feedback devices. In some implementations, the computing system causes performance of the haptic feedback signal by providing the haptic feedback signal to one or more computing devices associated with the user that each include one or more haptic feedback devices configured to provide haptic feedback to the user. For example, the one or more computing devices may include a smartwatch device, a wireless audio playback computing device, a wearable computing device, an AR/VR device, etc.

It should be noted that the one or more haptic feedback devices may include any manner of haptic feedback device(s) sufficient to perform a haptic feedback signal. For example, the one or more haptic feedback devices may include a resistance device that applies a resistance to a user input device, one or more vibration devices located within a computing device, a haptic texture device configured to simulate a texture on a display device or a touch input device, an actuator located within a computing device, an audio output device, etc.

In some implementations, the computing system can obtain a second output of the machine-learned model and an associated second confidence metric. The computing system can receive data indicative of an input associated with the second output of the machine-learned model from the user (e.g., the user of the computing system, etc.). The computing system can determine one or more modifications for the haptic feedback signal based at least in part on a difference between the confidence metric and the second confidence metric. The computing system can cause application of the one or more modifications to the haptic feedback signal. For example, the computing system may send data indicative of the modifications to the haptic feedback device(s). For another example, the computing system may modify the haptic feedback signal based on the modification(s) to obtain a modified haptic feedback signal, and may then cause performance of the modified haptic feedback signal via the haptic feedback device(s).

As an example, the second confidence metric may be greater than the first confidence metric (e.g., a confidence metric of 80% vs a confidence metric of 65%, etc.). The one or more modifications for the haptic feedback signal can increase the haptic feedback signal based on the difference between the second confidence metric and the confidence metric. As another example, the second confidence metric may be greater than the first confidence metric. The one or more modifications for the haptic feedback signal can decrease the haptic feedback signal based on the difference between the second confidence metric and the confidence metric.

In some implementations, the confidence metric is indicative of a historic accuracy of the machine-learned model. For example, the machine-learned model may be a model that can perform multiple tasks (e.g., a large language model, etc.). A historic accuracy can be established for each task. Based on the input, the confidence metric can indicate the historic accuracy of the task associated with the input.

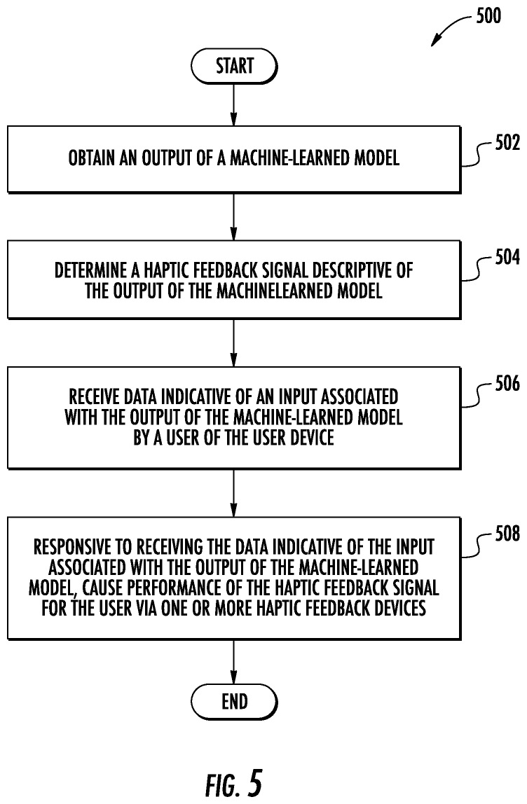

FIG. 5 depicts a flow chart diagram of an example method 500 to describe an output of a machine-learned model via haptic feedback according to example embodiments of the present disclosure. Although FIG. 5 depicts steps performed in a particular order for purposes of illustration and discussion, the methods of the present disclosure are not limited to the particularly illustrated order or arrangement. The various steps of the method 500 can be omitted, rearranged, combined, and/or adapted in various ways without deviating from the scope of the present disclosure.

At 502, a computing system can obtain an output of a machine-learned model. Specifically, the output can be any type or manner of output that is generated or otherwise obtained via one or more machine-learned models. In some implementations the output can be an output that selects a first entity from a plurality of entities. For example, the plurality of entities can be a plurality of settings options (e.g., temperature settings on a thermostat, degrees of brightness, contrast, tone, etc. for a display device, a degree of volume for an audio playback device or application, rendering settings for an application, selectable settings elements in a user interface, etc.). For another example, the plurality of entities can be a plurality of locations (e.g., restaurants, locations of interest, shopping locations, etc.). For another example, the plurality of entities may be a plurality of operations of an operating system (e.g., cut, copy, paste, save data, share data, delete, etc.). For another example, the plurality of entities may be a plurality of media selections (e.g., songs, videos, movies, television episodes, video games, etc.). For another example, the plurality entities may be a plurality of data types (e.g., image data, video data, audio data, multimedia data, Augmented Reality (AR)/Virtual Reality (VR) data, textual content, etc.).

At 504, the computing system can determine a haptic feedback signal descriptive of the output of the machine-learned model. For example, the output of the machine-learned model may indicate a degree of urgency. The computing system (e.g., a computing device utilized by a user, a computing system communicatively coupled to a user device, etc.) may generate a notification for a user. Data indicative of the notification, or the content of the notification, can be processed with the machine-learned model to obtain the output. The output can indicate a degree of urgency associated with the output. For example, a notification for an email likely to be spam mail may have a relatively low degree of urgency while a notification for an emergency weather event may have a relatively high degree of urgency. The haptic feedback signal can describe the sense of urgency. To follow the previous example, performance of the haptic feedback signal for the spam mail may cause a small vibrational effect from vibrational haptic feedback devices, while performance of the haptic feedback signal for the emergency weather event may cause a very large vibrational effect from vibrational haptic feedback devices in addition to a noise from an audio playback device of the computing device.

For another specific example, the output can be a recommendation output that recommends a first entity for the user of the user device from a plurality of entities. The plurality of entities can be a plurality of streamable videos available via a video streaming application, and the first entity can be a streamable video recommended to the user (e.g., based on user historical data, etc.). The haptic feedback signal can indicate the first entity to the user by causing a haptic feedback effect when performed. For example, the haptic feedback signal may cause a vibrational effect when the user is focusing on the first entity in a video selection interface (e.g., when the user is hovering over the first entity with a cursor element, when the user is touching the first entity via a touchscreen, when a gaze of the user is determined to be focusing on the first entity, etc.).

Additionally, or alternatively, in some implementations the haptic feedback signal can describe one or more characteristics of the first entity. To follow the previous example, the user may have already viewed the first entity (e.g., the streamable video). When performed, the haptic feedback signal can communicate to the user that the user has already viewed the first entity. For another example, the streamable video may include mature content. When performed, the haptic feedback signal can communicate to the user that the streamable video includes mature content. For yet another example, the streamable video may be a movie that corresponds to a certain genre. When performed, the haptic feedback signal can indicate the genre to the user (e.g., by producing different vibrational patterns for different genres, by producing different simulated textures on a touchscreen device for different genres, etc.).

At 506, the computing system can receive data indicative of an input associated with the machine-learned model by a user of the user device as previously described with regards to step 406 of FIG. 4.

At 508, the computing system, responsive to receiving the data indicative of the input associated with the output of the machine-learned model, can cause performance of the haptic feedback signal for the user via one or more haptic feedback devices as described with regards to step 408 of FIG. 4.

### Additional Disclosure

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method for indicating confidence in a machine-learned output via haptic feedback, comprising:
obtaining, by a user computing device comprising one or more processors, an output of a machine-learned model and an associated confidence metric, wherein the confidence metric is indicative of a degree of confidence in the output of the machine-learned model;
determining, by the user computing device, a haptic feedback signal indicative of the confidence metric;
receiving, by the user computing device, data indicative of an input associated with the output of the machine-learned model by a user of the user computing device; and
responsive to receiving the data indicative of the input associated with the output of the machine-learned model, causing, by the user computing device, performance of the haptic feedback signal for the user via one or more haptic feedback devices.

2. The computer-implemented method of claim 1, wherein:
the output of the machine-learned model comprises a classification output that assigns a classification to an entity; and
wherein the haptic feedback signal indicates the degree of confidence in the classification assigned to the entity.

3. The computer-implemented method of claim 2, wherein causing the performance of the haptic feedback signal comprises:
providing, by the user computing device, the haptic feedback signal to the one or more haptic feedback devices.

4. The computer-implemented method of claim 4, wherein obtaining the output of the machine-learned model comprises:
processing, by the user computing device, input data with the machine-learned model to obtain the output; and
determining, by the user computing device, the confidence metric associated with the output based at least in part on one or more prior outputs of the machine-learned model.

5. The computer-implemented method of claim 1, wherein causing the performance of the haptic feedback signal comprises:
providing, by the user computing device, the haptic feedback signal to one or more computing devices associated with the user that each comprise one or more haptic feedback devices configured to provide haptic feedback to the user.

6. The computer-implemented method of claim 5, wherein the one or more computing devices associated with the user comprise at least one of:
a smartwatch device;
a wireless audio playback computing device;
a wearable computing device; or
an Augmented Reality (AR)/Virtual Reality (VR) device.

7. The computer-implemented method of claim 3, wherein the one or more haptic feedback devices comprise at least one of:
a resistance device that applies a resistance to a user input device of the user computing device;
one or more vibration devices located within the user computing device;
a haptic texture device configured to simulate a texture on a display device or a touch input device of the user computing device;
an actuator located within the user computing device; or an audio output device of the user computing device.

8. The computer-implemented method of claim 1, wherein the method further comprises:
obtaining, by the user computing device, a second output of the machine-learned model and an associated second confidence metric.

9. The computer-implemented method of claim 8, wherein the method further comprises:
receiving, by the user computing device, data indicative of an input associated with the second output of the machine-learned model by the user of the user computing device;
determining, by the user computing device, one or more modifications for the haptic feedback signal based at least in part on a difference between the confidence metric and the second confidence metric; and
causing, by the user computing device, application of the one or more modifications to the haptic feedback signal.

10. The computer-implemented method of claim 9, wherein the second confidence metric is greater than the confidence metric; and
wherein determining the one or more modifications comprises determining, by the user computing device, one or more modifications for the haptic feedback signal to increase the haptic feedback signal based on the difference between the second confidence metric and the confidence metric.

11. The computer-implemented method of claim 10, wherein the second confidence metric is less than the confidence metric; and
wherein determining the one or more modifications comprises determining, by the user computing device, one or more modifications for the haptic feedback signal to decrease the haptic feedback signal based on the difference between the second confidence metric and the confidence metric.

12. The computer-implemented method of claim 1, wherein the confidence metric is indicative of a historic accuracy of the machine-learned model.

13. The computer-implemented method of claim 1, wherein the input associated with the output of the machine-learned model by the user of the user computing device comprises:
a touch input to a touchscreen device of the user computing device that selects an interface element associated with the output;
a touch input to the touchscreen device that selects a region of the touchscreen device within a certain proximity of the interface element associated with the output;
a spoken utterance to an audio capture device of the user computing device that indicates the output; or
a gesture input captured by a video capture sensor or one or more movement sensors of the user computing device that indicates the output.

14. The computer-implemented method of claim 1, wherein determining the haptic feedback signal indicative of the confidence metric comprises determining, by the user computing device, the haptic feedback signal indicative of the confidence metric based at least in part on user historical data that is descriptive of one or more prior haptic feedbacks signals that were previously performed for the user via the one or more haptic feedback devices.

15. A computing system, comprising:
one or more processors; and
one or more non-transitory computer-readable media that store instructions that, when executed by the one or more processors, cause the computing system to perform operations, the operations comprising:
obtaining an input for a machine-learned model from a user computing device of a user;
processing the input with the machine-learned model to obtain an output and an associated confidence metric, wherein the confidence metric is indicative of a degree of confidence in the output;
determining a haptic feedback signal indicative of the confidence metric; and
providing the haptic feedback signal to the user computing device, wherein the haptic feedback signal is configured to be performed for the user by one or more haptic feedback devices of the user computing device and/or one or more haptic feedback devices of a computing device communicatively coupled to the user computing device.

16. The computing system of claim 15, wherein providing the haptic feedback signal to the user computing device further comprises providing the output to the user device.

17. The computing system of claim 16, wherein the output of the machine-learned model comprises a classification output that assigns a classification to an entity; and
wherein the haptic feedback signal indicates the degree of confidence in the classification assigned to the entity.

18. The computing system of claim 17, wherein the computing device communicatively coupled to the user computing device comprises:
a smartwatch device;
a wireless audio playback computing device;
a wearable computing device; or
an Augmented Reality (AR)/Virtual Reality (VR) device.

19. The computing system of claim 18, wherein determining the haptic feedback signal indicative of the confidence metric comprises determining the haptic feedback signal indicative of the confidence metric based at least in part on user historical data that is descriptive of one or more prior haptic feedbacks signals that were previously performed for the user via the one or more haptic feedback devices of the user device and/or the one or more haptic feedback devices of the computing device communicatively coupled to the user device.

20. One or more non-transitory computer-readable media that store instructions that, when executed by one or more processors of a computing system, cause the computing system to perform operations, the operations comprising:
obtaining an output of a machine-learned model;
determining a haptic feedback signal, wherein the haptic feedback signal is descriptive of the output of the machine-learned model;
receiving data indicative of an input associated with the output of the machine-learned model by a user of a user device; and
responsive to receiving the data indicative of the input associated with the output of the machine-learned model, causing performance of the haptic feedback signal for the user via one or more haptic feedback devices.

21. The one or more non-transitory computer-readable media of claim 20, wherein the output of the machine-learned model selects a first entity from a plurality of entities; and
wherein the haptic feedback signal is configured to indicate the first entity to the user from the plurality of values.

22. The one or more non-transitory computer-readable media of claim 21, wherein the output comprises a recommendation output that recommends the first entity for the user from the plurality of entities.

23. The one or more non-transitory computer-readable media of claim 22, wherein the plurality of entity respectively comprise a plurality of:
settings options for a setting of an application or a device;
locations;
applications;
operations of an operating system; or
media selections.

24. The one or more non-transitory computer-readable media of claim 20, wherein the output of the machine-learned model selects a data type of a plurality of data types; and
wherein the haptic feedback signal is descriptive of the data type.

25. The one or more non-transitory computer-readable media of claim 20, wherein the output of the machine-learned model indicates a degree of urgency; and
wherein the haptic feedback signal is descriptive of the degree of urgency.
